(19) United States
(12) Patent Application Publication
(10) Pub. No.: US 2026/0188636 A1
(43) Pub. Date: Jul. 2, 2026

(54) METHODS AND SYSTEMS FOR SAMPLE VOLUME DETERMINATION

(71) Applicant: DH Technologies Development Pte. Ltd., Singapore (SG)

(72) Inventors: Heguang JI, Singapore (SG); Chang LIU, Concord (CA); Jing MA, Singapore (SG)

(73) Assignee: DH Technologies Development Pte. Ltd., Singapore (SG)

(21) Appl. No.: 19/129,968

(22) PCT Filed: Nov. 16, 2023
(86) PCT No.: PCT/IB2023/061618

§ 371 Date: May 14, 2025

Related U.S. Application Data
(60) Provisional application No. 63/384,112, filed on Nov. 17, 2022.

(51) Int. Cl. H01J 49/04; H01J 49/02

(52) U.S. Cl. CPC H01J 49/0431; H01J 49/022

(57) ABSTRACT

Methods and systems of determining sampling triggers for an analysis device, the methods and systems including obtaining a frequency of sampling triggers, a cycle time to acquire a single data point, a number of data points to be acquired for a single peak, and a baseline signal width of a single sampling trigger peak, determining a desired number of sampling triggers to be performed and a delay time between sampling events based on the frequency of sampling triggers, the cycle time, the number of data points to be acquired for the single peak, and the baseline signal width of the single sampling trigger peak, and performing a measurement of a sample by executing the determined desired number of sampling triggers from the sample.

### CROSS-REFERENCE TO RELATED APPLICATIONS

This application is being filed on Nov. 15, 2023, as a PCT International Patent Application that claims priority to and the benefit of U.S. Provisional Patent Application No. 63/384,112, filed on Nov. 17, 2022, which is hereby incorporated by reference in its entirety.

### BACKGROUND

The volume of a sample to be analyzed is a factor in detection accuracy and sensitivity, and in analysis reproducibility. When analyzing a large number of samples, the volume of each sample is typically kept to be about the same, even when conditions may warrant a variation in the volume of any given sample.

### SUMMARY

In one aspect of the present disclosure, a method for determining sampling triggers for an analysis device, the method including obtaining a frequency of sampling triggers, a cycle time to acquire a single data point, a number of data points to be acquired for a single peak, and a baseline signal width of a single sampling trigger peak, determining a desired number of sampling triggers to be performed and a delay time between sampling events based on the frequency of sampling triggers, the cycle time, the number of data points to be acquired for the single peak, and the baseline signal width of the single sampling trigger peak, and performing a measurement of a sample by executing the determined desired number of sampling triggers from the sample.

In various examples of the above aspect, determining the desired number of sampling triggers includes calculating n=(t_{cycle}×N_{datapoints}−W₁)×reprate+1, wherein n is the desired number of sampling triggers, t_{cycle} is the cycle time, N_{datapoints} is the number of data points, W₁ is the baseline signal width of the peak or a single sampling trigger or droplet ejection, and reprate is the frequency of sampling triggers. In another example, the number of data points to be acquired for the single peak is in a range of 7 to 12. In a further example, a coefficient of variation of a signal intensity for a plurality of measurements is equal to or lower than 10%. For example, the cycle time is in a range of 100 ms to 120 ms and up to four measurements can be performed by the analysis device. In another example, the cycle time is in a range of 200 to 250 ms and up to nine measurements can be performed by the analysis device. As another example, the cycle time is in a range of 300 to 350 ms and up to thirteen measurements can be performed by the analysis device.

In further examples of the above aspect, the method further includes obtaining an additional sampling delay time, and determining the sampling delay time between sampling events includes calculating Td=t_{cycle}×N_{datapoints}+Tad, wherein Td is the sampling delay time and Tad is the additional sampling delay time. In yet another example, the sampling triggers are droplet ejections, the sampling delay time is a droplet ejection delay time, and the additional sampling delay time includes an additional droplet ejection delay time. In another example, the sampling triggers are droplet ejections, and executing the determined desired number of sampling triggers includes ejecting a same desired number of droplets from the sample. In an additional example, the method further includes ionizing the ejected desired number of droplets, and capturing one or more mass spectra for the ionized droplets. In a further example, the method further includes ionizing the ejected desired number of droplets, and capturing one or more mass spectra for the ionized droplets.

In another aspect of the present disclosure, a sample analyzing system includes a sample receiver, an analysis device fluidically coupled to the sample receiver, a processor operatively coupled to the sample receiver and to the analysis device, and a memory coupled to the processor. In various examples, the memory stores instructions that, when executed by the processor, perform a set of operations. In examples, the set of operations includes obtaining, via the processor, a frequency of sampling triggers, a cycle time to acquire a single data point, a number of data points to be acquired for a single peak, and a baseline signal width of a single sampling trigger peak, determining, via the processor, a desired number of sampling triggers to be performed and a delay time between sampling events based on the frequency of sampling triggers, the cycle time, the number of data points to be acquired for the single peak, and the baseline signal width of the single sampling trigger peak, and performing, via the analysis device, a measurement of a sample by executing the determined desired number of sampling triggers from the sample.

In various examples, the set of instructions includes determining the desired number of sampling triggers by calculating n=(t_{cycle}×N_{datapoints}−W₁)×reprate+1, wherein n is the desired number of sampling triggers, t_{cycle} is the cycle time, N_{datapoints} is the number of data points, W₁ is the baseline signal width of the peak of a single sampling trigger or droplet ejection, and reprate is the frequency of sampling triggers. In a further example, the number of data points to be acquired for the single peak is in a range of 7 to 12. In other examples, a coefficient of variation of a signal intensity for a plurality of measurements is equal to or lower than 10%. In yet another example, the cycle time is in a range of 100 ms to 120 ms and up to four measurements can be performed by the analysis device. In a further example, the cycle time is in a range of 200 to 250 ms and up to nine measurements can be performed by the analysis device. In yet a further example, the cycle time is in a range of 200 to 250 ms and up to nine measurements can be performed by the analysis device.

In other examples of the above aspect, the set of instructions further includes obtaining an additional sampling delay time, and determining the sampling delay time between sampling events includes calculating Td=t_{cycle}×N_{datapoints}+Tad, wherein Td is the sampling delay time, and Tad is the additional sampling delay time. In yet another example, the sampling triggers are droplet ejections, the sampling delay time is a droplet ejection delay time, and the additional sampling delay time includes an additional droplet ejection delay time. In further examples, the sample analysis system further includes a sample ejector for ejecting a sample from a sample source, and a sample ionization device, the analysis device is a mass analysis device, the sampling triggers are droplet ejections, and the set of instructions further includes performing the determined desired number of sampling triggers by ejecting a same desired number of droplets from the sample via the sample ejector. In a further example, the set of instructions further includes ionizing the ejected desired number of droplets, and capturing one or more mass spectra for the ionized droplets. For example, the set of instructions further includes calculating a sample ejection volume based on the number of droplets and a volume of an individual droplet. In an example, the sample receiver includes an open port interface. In a further example, the sample ejector is a non-contact sample ejector.

The details of one or more techniques are set forth in the accompanying drawings and the description below. Other features, objects, and advantages of these techniques is apparent from the description, drawings, and claims.

### BRIEF DESCRIPTION OF THE DRAWINGS

FIG. 1 is schematic diagram illustrating one example mass analysis system in accordance with various aspects and examples of the present disclosure.

FIG. 2 is schematic diagram illustrating another example mass analysis system in accordance with various aspects and examples of the present disclosure.

FIG. 3 is a schematic diagram illustrating one example of the centralized control system in accordance with various aspects and examples of the present disclosure.

FIG. 4 is a schematic diagram illustrating one particular example of the computing device in accordance with various aspects and examples of the present disclosure.

FIG. 5 depicts a schematic view of an example system combining an acoustic droplet ejection system with a sampling interface and an ion source, in accordance with various aspects and examples of the present disclosure.

FIG. 6 illustrates a signal peak from a multi-triggering ejection event, in accordance with various aspects and examples of the present disclosure.

FIG. 7 illustrates data points taken from a signal peak, in accordance with various aspects and examples of the present disclosure.

FIG. 8 is a table illustrating mass analysis parameters, in accordance with various examples of the present disclosure.

FIG. 9 represents a flowchart illustrating a method for determining sampling triggers for an analysis device, in accordance with various examples of the disclosure.

Before one or more examples of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the terminology used herein is for the purpose of description and should not be regarded as limiting.

### DETAILED DESCRIPTION

### Selected Definitions

For the purposes of interpreting this specification, the following definitions will apply and whenever appropriate, terms used in the singular will also include the plural and vice versa. The definitions set forth below shall supersede any conflicting definitions in any documents incorporated herein by reference.

As used herein, the singular forms “a,” “an,” and “the,” include both singular and plural referents unless the context clearly dictates otherwise.

The terms “comprising,” “comprises,” and “comprised of” as used herein are synonymous with “including,” “includes,” or “containing,” “contains,” and are inclusive or open-ended and do not exclude additional, non-recited members, elements or method steps. It is appreciated that the terms “comprising,” “comprises,” and “comprised of” as used herein comprise the terms “consisting of,” “consists,” and “consists of.”

The recitation of numerical ranges by endpoints includes all numbers and fractions subsumed within the respective ranges, as well as the recited endpoints.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6, or ≥7, etc. of said members, and up to all said members.

Unless otherwise defined, all terms used in the present disclosure, including technical and scientific terms, have the meaning as commonly understood by one of ordinary skill in the art to which this disclosure belongs. By means of further guidance, term definitions are included to better appreciate the teaching of the present disclosure.

As used herein, “intensity” refers to the height of, or area under, a MS peak. For example, the peak can be output data from a measurement occurring in a mass spectrometer (e.g., as a mass-to-charge ratio (m/z)). The charge “z” represents a charge state of the isotope cluster. The value of the charge state can be any positive or negative integer, such as +1, +2, +3, or −1, −2, or −3. In accordance with some examples of the present disclosure, intensity information can be presented as a maximum height of the summary peak or a maximum area under the summary peak representing a m/z value.

In the following passages, different aspects of the present disclosure are defined in more detail. Each aspect so defined may be combined with any other aspect or aspects unless clearly indicated to the contrary.

Reference throughout this specification to “one example” or “an example” means that a particular feature, structure or characteristic described in connection with the example is included in at least one example of the present disclosure. Thus, appearances of the phrases “in one example” or “in an example” in various places throughout this specification are not necessarily all referring to the same example, but may. Furthermore, the particular features, structures or characteristics may be combined in any suitable manner, as would be apparent to a person skilled in the art from this disclosure, in one or more examples. Furthermore, while some examples described herein include some but not other features included in other examples, combinations of features of different examples are meant to be within the scope of the disclosure, and form different examples, as would be understood by those in the art. For example, in the appended claims, any of the claimed examples can be used in any combination.

In the present disclosure, reference is made to the accompanying drawings that form a part hereof, and in which are shown by way of illustration only of specific examples in which the present disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims.

### Ionization Devices

Although the sample ionization process is described above in the context of AEMS using ESI, other techniques of generating ionized samples may be used according to various examples of this disclosure. For example, ionized samples may be generated by desorption electrospray ionization (DESI), which is a combination of ESI and desorption ionization (DI) methods. In DESI, ionization takes place by directing an electrically charged mist to the sample surface that is a few millimeters away. The electrospray mist is pneumatically directed at the sample, thus forming splashed droplets that carry desorbed, ionized analytes. After ionization, the ions travel through air into the atmospheric pressure interface which is connected to the mass spectrometer.

Another ionization technique may include matrix-assisted laser desorption ionization (MALDI), which is an ionization technique that uses a laser energy absorbing matrix to create ions from large molecules with minimal fragmentation. In MALDI, a laser is fired at the matrix crystals in the dried-droplet spot. The matrix absorbs the laser energy; the matrix is desorbed and ionized (by addition of a proton) by this event. The hot plume produced during ablation contains many species: neutral and ionized matrix molecules, protonated and deprotonated matrix molecules, matrix clusters and nanodroplets.

Other ionization techniques may include rapid-fire mass spectrometry, liquid atmospheric pressure (LAP) MALDI, pneumatic ESI (which generates ions for mass spectrometry using electrospray by applying a high voltage to a liquid to produce an aerosol), and electron ionization (EI). EI may also be referred to as electron impact ionization or electron bombardment ionization, and is an ionization method in which energetic electrons interact with solid or gas phase atoms or molecules to produce ions. Any of the above techniques, as well as others that can perform sample ionization, may be used in examples of this disclosure.

### System for Mass Analysis

Examples of the present disclosure generally relate to high throughput systems and methods for analyzing a collection of substance samples using, e.g., mass spectrometry. Conventionally, the preparation and introduction of sample into a mass spectrometer is a relatively time-consuming process, particularly where rapid and efficient analysis of a sample pool containing multiple samples, which may or may not be analytically related, is desired. For instance, multiple different systems may have been used that were provided and controlled by separate entities and/or devices. For example, a liquid handling system would be used for preparation of samples, an ejection system would be used for ejecting samples into a port or interface, and mass spectrometry system would be used for the actual analysis of the samples. Each system needs to be separately controlled and operated, which lead to significant challenges and inefficiencies, including requirement of manual interaction and intervention for many of the operations.

The systems provided in the present disclosure advantageously include a central control system that is able to control the underlying subsystems used in the sample analysis process. For example, a script or set of operations may be generated at the central control system or controller that allows for control of the subsystems such that the subsystems are able to work synchronously across different types of operations performed by each of the subsystems. To accomplish such synchronicity across the subsystems, additional mechanical devices, such as robotics, may be incorporated into the overall system to handle transitions of materials between the systems. Thus, the central controller is able to interface with the various subsystems and transition robotics to more efficiently control each of the operations performed by the subsystems. Furthermore, the present systems advantageously include a computing subsystem and various functional modules thereof configured to efficiently process the data generated from multiple samples, reliably determine the data-sample correlation for a large pool of samples, generate mass spectra for each test sample, analyze the generated mass spectra, and provide real-time feedback to other subsystems. As a result, the efficiency and productivity of the entire system may be improved.

### Determining Sample Ejection Volume

The volume of a sample to be analyzed is a factor in detection accuracy and sensitivity, and in analysis reproducibility. When analyzing a large number of samples, the volume of each sample is typically about the same, even when conditions may warrant a variation in the volume of any given sample. In some instances, it may be desirable to vary the number of data points to be taken in order to account for variations due to, e.g., equipment requirements. Varying the number of data points such as, e.g., the number of sample droplets ejected from e.g., a well of a well plate, is typically challenging. As such, a technical problem may exist in the lack of the ability to control and vary the number of sample droplets ejected from a well. For example, in order to get an acceptable data reproducibility, at least 8-10 data points across a signal peak on a chronogram may be advantageous, and taking 8-10 data points may require a corresponding increase in the duration of a cycle time, and thus may require a longer signal duration. In examples, the cycle time is the time necessary to collect a single mass spectrum or a group of mass spectra. As a result, the inability to flexibly determine an appropriate sample volume for a given droplet ejection, and to control the signal duration during analysis may present a technical problem. In order to address the above-discussed technical problem, examples of the disclosure provide methods and systems to automatically improve or optimize the ejection volume and the ejection delay time for each sample by dynamically controlling both the ejection volume of a droplet and the delay time between ejected droplets.

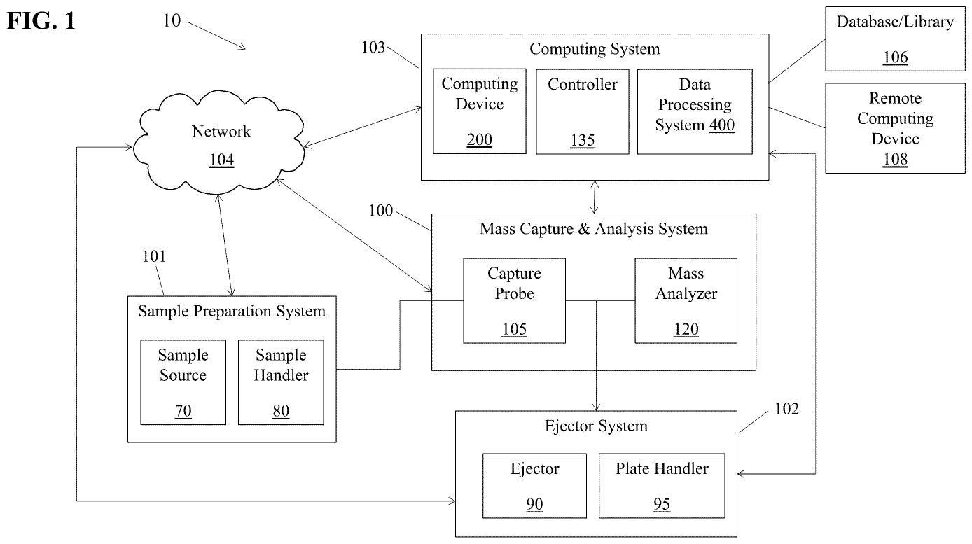

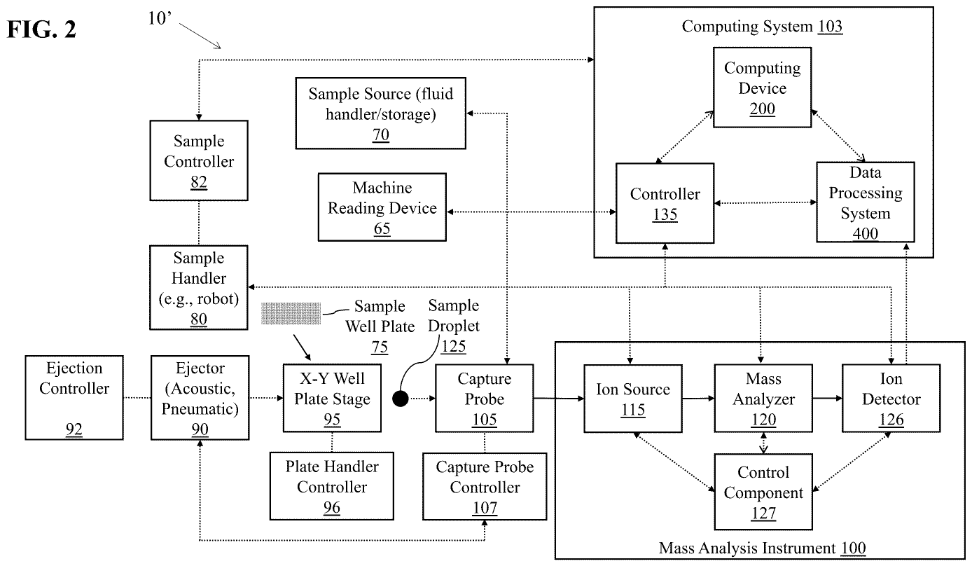

Now referring to FIGS. 1 and 2, examples of the present disclosure are illustrated and described. The descriptions of FIGS. 1 and 2 are concurrent unless otherwise noted. In the illustrated examples, the system 10 or 10′ can each include, in various combinations, pluralities of components, including some or all of: a mass capture and analysis system 100, a sample preparation system 101, an ejector system 102, a computing system 103, a network 104, a database/library 106, and a remote computing device 108. In the example illustrated in FIG. 1, various systems 100, 101, 102, 103, 104, and 106 are subsystems of the system 10 and may be operably connected between or among each other. For example, the computing system 103 is in bilateral communication with the mass capture and analysis system 100, and is also in bilateral communication with the ejector system 102; the sample preparation system 101 is in communication with the mass capture and analysis system 100, and is also in communication with the ejector system 102; the mass capture and analysis system 100 is in communication with the ejector system 102; and the database 106 and the remote computing device 108 are each in communication with the computing system 103.

In some examples, the mass capture and analysis system 100 may be a mass analysis instrument 100. The mass capture and analysis system 100 may be a mass spectrometer system including a mass analyzer 120 for analyzing ions generated from ionization of a sample. The mass capture and analysis system 100 may also include a capture device or probe 105 that captures the sample and provides the sample to other components of the mass capture and analysis system 100. In other examples (such as shown in FIG. 2), the capture probe 105 may be located externally from the mass analysis instrument 100. For instance, the capture probe 105 may be part of the ejection system 102.

It will also be appreciated by a person skilled in the art and in light of the teachings herein that the mass analyzer 120 can have a variety of configurations. Generally, the mass analyzer 120 is configured to process (e.g., filter, sort, dissociate, detect, etc.) sample ions generated by the ion source 115. By way of non-limiting example, the mass analyzer 120 can be a triple quadrupole mass spectrometer, or any other mass analyzer known in the art and modified in accordance with the teachings herein. Other non-limiting, example mass spectrometer systems that can be modified in accordance with various aspects of the systems, devices, and methods disclosed herein can be found, for example, in an article entitled “Product ion scanning using a Q-q-Q linear ion trap (Q TRAP) mass spectrometer” (James W. Hager and J. C. Yves Le Blanc; Rapid Communications in Mass Spectrometry; 2003; 17:1056-1064); and U.S. Pat. No. 7,923,681, the disclosures of which are hereby incorporated by reference herein in their entireties.

Other configurations, including but not limited to those described herein and others known to those skilled in the art, can also be utilized in conjunction with the systems, devices, and methods disclosed herein. For instance, other suitable mass spectrometers include single quadrupole, triple quadrupole, time-of-flight (ToF), trap, and hybrid analyzers. It will further be appreciated that any number of additional elements can be included in the system 100 including, for example, an ion mobility spectrometer (e.g., a differential mobility spectrometer) that is disposed between the ionization source 115 and the mass analyzer detector 120 and is configured to separate ions based on their mobility difference between in high-field and low-field). Additionally, it is appreciated that the mass analyzer 120 can include a detector 126 that can detect the ions that pass through the analyzer 120 and can, for example, supply a signal indicative of the number of ions per second that are detected.

The sample preparation system 101 may include a sample source 70 and a sample handler 80. The sample source 70 and a sample handler 80 are operative to retrieve collections of samples from the sample source(s) and to deliver the retrieved collections to capture locations associated with sample capture probes 105. The systems may be operative to independently capture selected ones of the pluralities of samples at the capture locations from the pluralities of samples, to optionally dilute the samples and to transfer the captured samples to mass analysis instruments 100, 120 for mass analysis. In some examples, the sample source 70 may include a set of well plates in a storage housing and/or liquid for adding to well plates. The sample source 70 may include part of a liquid handling system that manipulates and/or injects liquid into the well plates. The sample handler 80 includes one or more electro-mechanical devices (e.g., robotics, conveyor belts, stages, etc.) that are capable of transferring the samples (e.g., well plates) from the sample source to other components of the sample preparation system 101 and/or to other systems, such as the ejection system 102 and/or the capture probe 105. As an example, the sample handler 80 may transfer a well plate from the sample preparation system 101 to the ejection system 102. More specifically, the sample handler 80 may transfer the well plate to a plate handler 95 of the ejection system 102. Accordingly, the sample preparation system 101 may also be referred to as a sample delivery system. In some examples, selected sample information (e.g. sample or compound ID, chemical structure of the target compound, or other sample information) could be obtained during the sample handling steps through the use of sample controller 82 and/or the sample handler 80, and communicated to the computing system 103 or the data processing system 400 thereof.

In addition to the plate handler 95, the ejection system 102 may include an ejector 90 that ejects droplets from the wells of the well plates. The ejector 90 may be any type of suitable ejector, such as an acoustic ejector, a pneumatic ejector, or other type of contactless ejector. In an example, the plate handler 95 receives a well plate from the sample handler 80. The plate handler 95 transports the plate to a capture location that may be aligned with the capture probe 105. Once in the capture location, the ejector 90 ejects droplets from one or more wells of the well plates. The plate handler 95 may include one or more electro-mechanical devices, such as a translation stage that translates the well plate in an x-y plane to align wells of the well plate with the ejector 90 and/or or the capture probe 105.

The computing system 103 includes computing resources, components, and modules that are operative to perform various functions including but not limited to: communicating with other subsystems, receiving and transmitting electrical signals with other subsystems or components thereof, receiving, responding to, and executing user instructions, performing calculations, processing raw data received from mass analyzer, performing splitting data, performing sample-dataset correlation, generating and analyzing mass spectrometry data, identifying, annotating, and assigning MS peaks of mass spectra, extracting spectral features from mass spectra, conducting library search, identifying analytes, and outputting analytical report to end users.

In some examples, the computing system 103 includes a computing device 200, a controller 135, and a data processing system 400. The computing device 200 may be in the form of electronic signal processors and operative to perform various computing functions. The controller 135 may be in the form of electronic signal processors and in electrical communication with other subsystems within the system 10 or 10′. The controller 135 is further configured to coordinate some or all of the operations of the pluralities of the various components of the system 10 or 10′. The data processing system 400 may include various components and modules operative to process mass spectrometry data and to provide real-time feedback to end users and other subsystems.

In some examples, a network 104 may be operably connected to any one or all of the subsystems or components in the system 10 or 10′. The network 104 is a communication network. In the example, the network 104 is a wireless local area network (WLAN). The network 104 may be any suitable type of network and/or a combination of networks. The network 104 may be wired or wireless and of any communication protocol. The network 104 may include, without limitation, the Internet, a local area network (LAN), a wide area network (WAN), a wireless LAN (WLAN), a mesh network, a virtual private network (VPN), a cellular network, and/or any other network that allows system 104 to operate as described herein.

In some examples, the system 10 or 10′ may further include one or more library/database 106. The database 106 can be a commercial database, or a private database containing analytical information from previously analyzed samples, or a combination of both. The library/database 106 includes chemical knowledge of standard of known compounds stored therein, including but not limited to chemical formula or elemental composition, neutral mass, monoisotopic mass, or mass of internal fragments thereof. In some examples, the computer system 103 is operative to perform a search using the database 106 and/or to compare data produced by the data processing system 400 to the retrieved data from the database 106 (such as molecular mass information or spectral features) to facilitate mass analysis and/or analyte identification.

Also illustrated in FIG. 2 are components of a sample delivery system for use in combination with the mass analysis instrument 100. The sample delivery system includes at least a sample source 70 for supplying a plurality of samples, a sample handler 80 for delivering the plurality of samples to a capture location, and a capture probe 105 for independently capturing one or more samples of the plurality of samples. In some aspects, the sample delivery system may further include a stage 95 for locating each sample for the plurality of samples proximate to a capture surface of the capture probe 105 and an ejector 90 for selectively ejecting that located sample into the capture surface of the capture probe.

In operation, a sample delivery system (including sample source 70 and sample handler 80) can iteratively deliver independent samples from a plurality of samples (e.g., a sample from a well of a well plate 75) to the capture probe 105. The capture probe 105 can dilute and transport each such delivered sample to the ion source 115 disposed downstream of the capture probe 105 for ionizing the diluted sample. A mass analyzer 120 can receive generated ions from the ion source 115 for mass analysis. The mass analyzer 120 is operative to selectively separate ions of interest from generated ions received from the ion source 115 and to deliver the ions of interest to an ion detector 126 that generates a mass spectrometer signal indicative of detected ions to the data processing system 400. In some aspects, the separate ions of interest may be indicated in an analysis instruction associated with that sample. In some aspects, the separate ions of interest may be indicated in an analysis instruction identified by an indicia physically associated with the plurality of samples.

In some aspects, the system 10 or 10′ may further include the generation, assignment, and use of identifiers associated with collections of samples and/or individual samples, and incorporation by one or more of components 70, 80, 95, 105, 100, etc. of identifier readers. For instance, an identifier associated with a well plate may be read or scanned by a machine reading device 65 as it leaves the sample source 70 and/or when the well plate is received by the stage 95. In such aspects, the identifier(s) may be used by the system to associate a corresponding one or more sets of instructions for use by the mass analysis instrument 100, 120 when analyzing transported sample droplets 125. In some aspects, the identifier may include an indicia physically associated with the plurality of samples. In some aspects, the indicia may be readable by optical, electrical, magnetic or other non-contact reading means. Indicia or identifiers in accordance with such aspects of the disclosure can include any characters, symbols, or other devices suitable for use in adequately identifying samples, sample collections, and/or handling or analysis instructions suitable for use in implementing the various aspects and examples of the present disclosure.

Additional details regarding implementation and operation of system 10 or 10′ in accordance with various aspects and examples of the present disclosure can be explained with reference to the Figures. FIGS. 1 and 2 present system diagrams illustrating examples of a system 10 or 10′, each example including a sample handler 80 and an associated controller 135, which may be, for example, a Biomek computer available from Beckman Coulter Life Sciences, is in operative communication with a mass analysis instrument 100 and a controller for the capture probe 105, which may include, for example, an a SciexOS® computer available from Sciex. The SciexOS® computer includes a control component 107 for the capture probe 105, represented for example by Sciex open port probe (OPP) (also referred to as an open port interface (OPI)) software, and a control component 127 for the mass analysis instrument 100, which may be the Analyst® computer. The mass analysis instrument 100 and capture probe controller 107 may be further in operative communication with an ejector 90 and an X-Y Well Plate Stage 95 and plate handler controller 96, which may be, for example, a liquid droplet ejector with embedded computer or processor. For the purposes of this application, these distributed controller components may collectively be considered to be a system controller, and depending upon the configuration may be centralized, or distributed as is the case here. For instance, one of the controllers or controller components may send signals to the other controllers to control the respective devices.

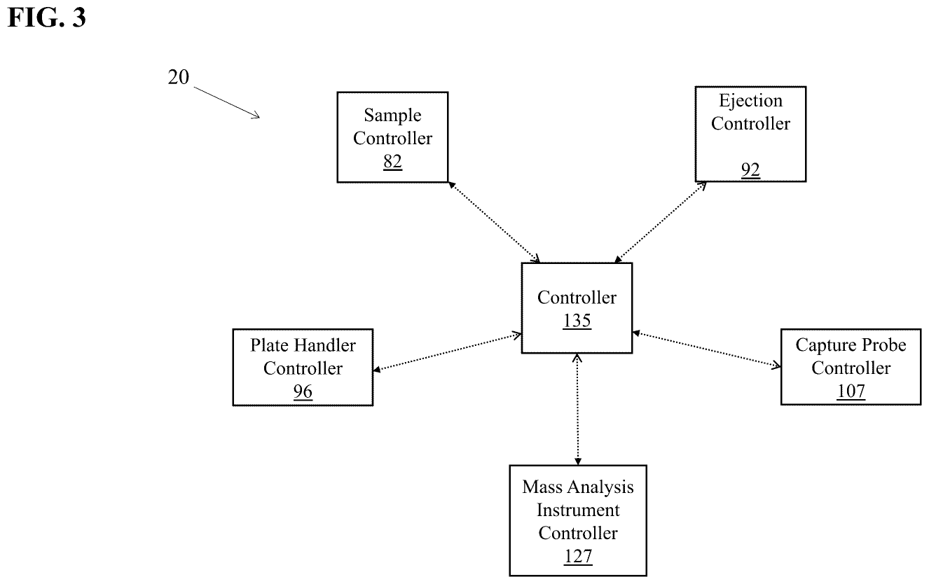

FIG. 3 illustrates one example of a centralized control system 20 for controlling the operation of the system 10 or 10′, according to FIGS. 1 and 2. In the illustrated example, the centralized control system 20 includes the controllers for each subsystem of the system 10 or 10′, including 135, 82, 92, 96, 107, and 127. The controller 135 may be a controller for the mass analysis instrument 100 and may be used as the primary controller for controlling components in addition to those components housed within the mass analysis instrument 100. As such, the controller 135 may be considered the main or central controller that orchestrates, or communicates with, the other controllers to carry out the operations discussed herein in a more efficient manner.

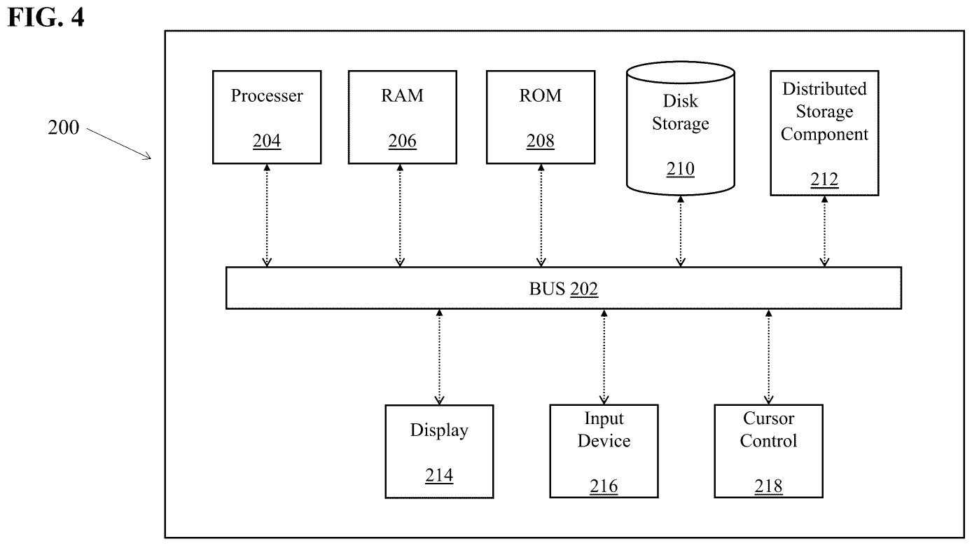

Now referring to FIG. 4, an example of the computing device 200 according to FIGS. 1 and 2 is illustrated and described. It is noted that the computing system 103 of the system 10 or 10′ may include a single computing device 200 or may include a plurality of distributed computing devices 200 in operative communication with components of a mass analysis instrument 100. In the illustrated example of FIG. 4, the computing device(s) 200 may include a bus 202 or other communication mechanism of similar function for communicating information, and at least one processing element 204 coupled with bus 202 for processing information. As is appreciated by those skilled in the relevant arts, such at least one processing element 204 may include a plurality of processing elements or cores, which may be packaged as a single processor or in a distributed arrangement. Furthermore, in some examples, a plurality of virtual processing elements 204 may be included in the computing device 200 to provide the control or management operations for the mass analysis instrument 100.

Computing device 200 may also include one or more volatile memory(ies) 206, which can for example include random access memory(ies) (RAM) or other dynamic memory component(s), coupled to one or more busses 202 for use by the at least one processing element 204. Computing device 200 may further include static, non-volatile memory(ies) 208, such as read only memory (ROM) or other static memory components, coupled to busses 202 for storing information and instructions for use by the at least one processing element 204. A storage component 210, such as a storage disk or storage memory, may be provided for storing information and instructions for use by the at least one processing element 204. As is appreciated, in some examples the computing device 200 may include a distributed storage component 212, such as a networked disk or other storage resource available to the computing device 200.

Computing device 200 may be coupled to one or more displays 214 for displaying information to a computer user. Optional user input devices 216, such as a keyboard and/or touchscreen, may be coupled to a bus for communicating information and command selections to the at least one processing element 204. An optional graphical input device 218, such as a mouse, a trackball or cursor direction keys for communicating graphical user interface information and command selections to the at least one processing element. The computing device 200 may further include an input/output (I/O) component, such as a serial connection, digital connection, network connection, or other input/output component for allowing intercommunication with other computing components and the various components of the mass analysis instrument 100.

In various examples, computing device 200 can be connected to one or more other computer systems a network to form a networked system. Such networks can for example include one or more private networks, or public networks such as the Internet. In the networked system, one or more computer systems can store and serve the data to other computer systems. The one or more computer systems that store and serve the data can be referred to as servers or the cloud, in a cloud computing scenario. The one or more computer systems can include one or more web servers, for example. The other computer systems that send and receive data to and from the servers or the cloud can be referred to as client or cloud devices, for example. Various operations of the mass analysis instrument 100 may be supported by operation of the distributed computing systems.

Computing device 200 may be operative to control operation of the components of the mass analysis instrument 100 and the sample delivery components 70, 80, 95, 105 through controller(s) 135 and to handle data generated by components of the mass analysis instrument 100 through the data processing system 400. In some examples, analysis results are provided by computing device 200 in response to the at least one processing element 204 executing instructions contained in memory 206 or 208 and performing operations on data received from the mass analysis instrument 100. Execution of instructions contained in memory 206 or 208 by the at least one processing element 204 can render the mass analysis instrument 100 and associated sample delivery components operative to perform methods described herein. Alternatively, hard-wired circuitry may be used in place of or in combination with software instructions to implement the present teachings. Thus, implementations of the present teachings are not limited to any specific combination of hardware circuitry and software.

The term “computer-readable medium” as used herein refers to any media that participates in providing instructions to processor 204 for execution. Such a medium may take many forms, including but not limited to, non-volatile media, volatile media, and transmission media. Non-volatile media includes, for example, optical or magnetic disks, such as disk storage 210. Volatile media includes dynamic memory, such as memory 206. Transmission media includes coaxial cables, copper wire, and fiber optics, including the wires that include bus 202.

Common forms of computer-readable media or computer program products include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 204 for execution. For example, the instructions may initially be carried on the magnetic disk of a remote computer. The remote computer can load the instructions into its dynamic memory and send the instructions over a telephone line using a modem. A modem local to computer system 200 can receive the data on the telephone line and use an infra-red transmitter to convert the data to an infra-red signal. An infra-red detector coupled to bus 202 can receive the data carried in the infra-red signal and place the data on bus 202. Bus 202 carries the data to memory 206, from which processor 204 retrieves and executes the instructions. The instructions received by memory 206 may optionally be stored on storage device 210 either before or after execution by processor 204.

In accordance with various examples, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

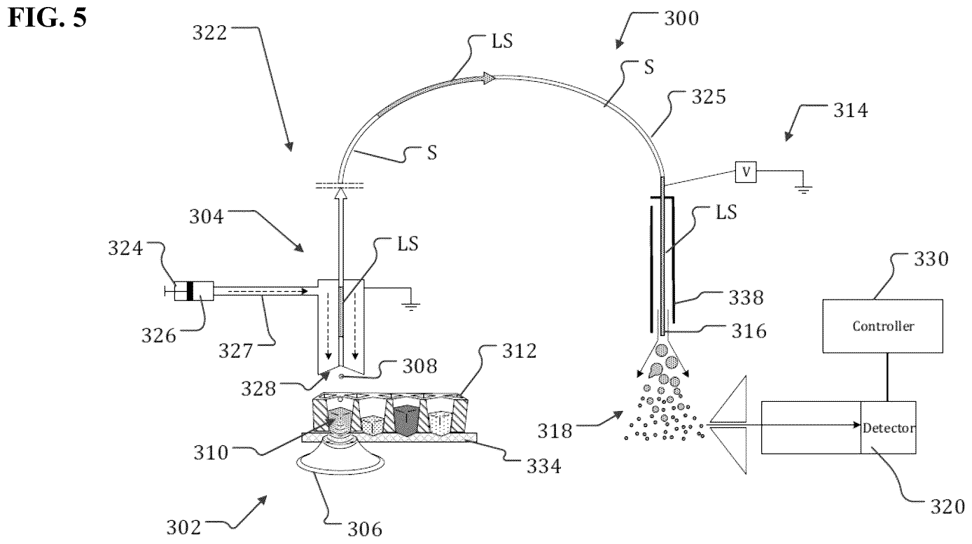

FIG. 5 depicts a schematic view of an example acoustic ejection mass spectrometry (AEMS) system 300 combining an acoustic droplet ejection (ADE) device 302 with an open port interface (OPI) 304 and an ESI device source 314. The system 300 provides an example of an integration and physical connection between the ejection system 102, the capture probe 105, and the mass analysis instrument 100.

The ADE 302 includes an acoustic ejector 306 that is configured to eject a droplet 308 from a reservoir 312 into the open end of a sample receiver such as, e.g., sampling OPI 304. The acoustic ejector 306 is one example of the ejector 90, and the sampling OPI 304 is one example of the capture probe 105. As shown in FIG. 5, the example system 300 generally includes the sampling OPI 304 in liquid communication with the ESI source 314 for discharging a liquid containing one or more sample analytes (e.g., via electrospray electrode 316) into an ionization chamber 318, and a mass analyzer detector (depicted generally at 320) in communication with the ionization chamber 318 for downstream processing and/or detection of ions generated by the ESI source 314. The ESI source 314 is an example of the ion source 115, and the mass analyzer detector 320 is an example of the ion detector 126.

Due to the configuration of the nebulizer probe 338 and electrospray electrode 316 of the ESI source 314, samples ejected therefrom are in the gas phase. A liquid handling system 322 (e.g., including one or more pumps 324 and one or more conduits 325) provides for the flow of a transport liquid from a solvent reservoir 326 to the sampling OPI 304 and from the sampling OPI 304 to the ESI source 314. The solvent reservoir 326 (e.g., containing a liquid, desorption solvent) can be liquidly coupled to the sampling OPI 304 via a supply conduit 327 through which the transport liquid can be delivered at a selected volumetric rate by the pump 324 (e.g., a reciprocating pump, a positive displacement pump such as a rotary, gear, plunger, piston, peristaltic, diaphragm pump, or other pump such as a gravity, impulse, pneumatic, electrokinetic, and centrifugal pump), all by way of non-limiting example. The flow of transport liquid into and out of the sampling OPI 304 occurs within a sample space accessible at the open end such that one or more droplets 308 can be introduced into the liquid boundary 328 at the sample tip and subsequently delivered to the ESI source 314.

The ADE 302 is configured to generate acoustic energy that is applied to a liquid contained within a well or reservoir 310 of a well plate 312 that causes one or more droplets 308 to be ejected from the reservoir 310 into the open end of the sampling OPI 304. The well plate 312 is an example of the well plates 75 discussed above. The acoustic energy is generated from an acoustic ejector 306, which is an example of the ejector 90 discussed above. The well plate 312 may reside on a movable stage 334, which is an example of the plate stage 95 discussed above.

A controller 330 can be operatively coupled to the ADE 302 and can be configured to operate any aspect of the ADE 302 (e.g., focusing structures, acoustic ejector 306, automation elements for moving a movable stage 334 so as to position a reservoir 310 into alignment with the acoustic ejector 306 and/or the OPI 304, etc.). This enables the ADE 302 to eject droplets 308 into the sampling OPI 304 as otherwise discussed herein substantially continuously or for selected portions of an experimental protocol by way of non-limiting example. Controller 330 can be, but is not limited to, a microcontroller, a computer, a microprocessor, or any device capable of sending and receiving control signals and data. Wired or wireless connections between the controller 330 and the remaining elements of the system 300 are not depicted but would be apparent to a person of skill in the art. The controller 330 may be any of the controllers discussed above and may be responsible for controlling the mass analysis instrument 100 and/or the sample delivery system 101 as well.

As shown in FIG. 5, the ESI source 314 can include a source 336 of pressurized gas (e.g., nitrogen, air, or a noble gas) that supplies a high velocity nebulizing gas flow to the nebulizer probe 338 that surrounds the outlet end of the electrospray electrode 316. As depicted, the electrospray electrode 316 protrudes from a distal end of the nebulizer probe 338. The pressured gas interacts with the liquid discharged from the electrospray electrode 316 to enhance the formation of the sample plume and the ion release within the plume for sampling by mass analyzer detector 320, e.g., via the interaction of the high-speed nebulizing flow and jet of liquid sample. The liquid discharged may include discrete volumes of liquid samples LS received from each reservoir 310 of the well plate 312. Each received liquid sample LS is instantly diluted by a solvent after being captured within the OPI, with a dilution factor of about 1000 times (as flow of the solvent moves the liquid samples LS from the OPI 304 to the ESI source 314, the solvent is also referred to herein as the transport liquid). The nebulizer gas can be supplied at a variety of flow rates, for example, in a range from about 0.1 L/min to about 20 L/min, which can also be controlled under the influence of controller 330 (e.g., via opening and/or closing valve 340).

It is appreciated that the flow rate of the nebulizer gas can be adjusted (e.g., under the influence of controller 330) such that the flow rate of liquid within the sampling OPI 304 can be adjusted based, for example, on suction/aspiration force generated by the interaction of the nebulizer gas and the analyte-solvent dilution as it is being discharged from the electrospray electrode 316 (e.g., due to the Venturi effect). The ionization chamber 318 can be maintained at atmospheric pressure, though in some examples, the ionization chamber 318 can be evacuated to a pressure lower than atmospheric pressure.

### Automatic Data Processing

As discussed above, the present systems may be operative to analyze a large collection of substance samples and generate a large quantity of mass spectrometry data in a high throughput fashion. For example, one sample per second, or more than 50,000 samples per day. Systems 10 or 10′ discussed above according to the present disclosure advantageously provides an auto-triggered data processing function to avoid potential issues arising from the assay throughput bottleneck, to maintain a constant workflow of operations, to perform data processing and acquisition with matched speed as sample analysis, and to improve the overall productivity of the system.

### Determining Sample Ejection Volume

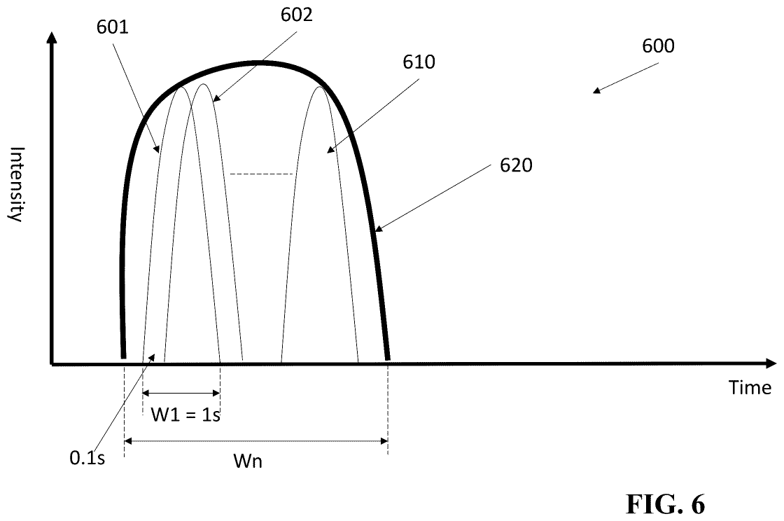

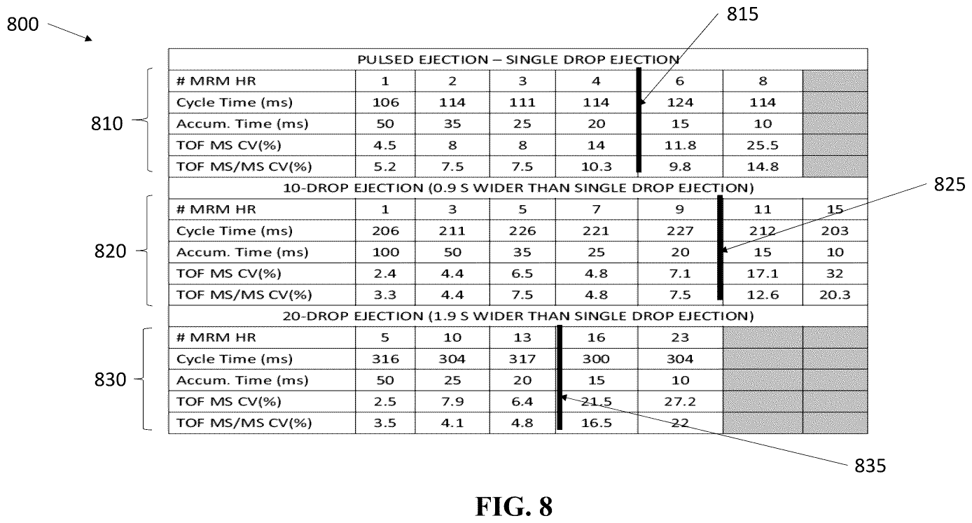

FIG. 6 illustrates a signal peak from a multi-triggering ejection event, in accordance with various aspects and examples of the present disclosure. In FIG. 6, a chronogram 600 illustrates a plurality of peaks 601, 602 . . . 610 being detected for a number of droplet ejections from the same well such as, e.g., 10 droplet ejections. For example, the droplet ejection frequency may be equal to 10 Hz, so that 10 droplet ejections may be performed for each second. As a result, the delay between droplet ejections may be equal to about 0.1 second. As another example, the cycle time, or time to complete a single mass spectrum or a group of mass spectra, may be equal to about 100 ms, as indicated in the examples discussed with respect to FIG. 8 below. Accordingly, as the first peak 601 is detected as a result of a droplet ejection, the peak 601 taking about one second to complete, another peak 602 is detected about 0.1 s after the start of peak 601, peak 602 being the result of a second droplet ejection and also taking about one second to complete. In examples, the baseline width of a single sampling trigger peak is illustrated as W1. For example, the single sampling trigger peak may be a single droplet ejection peak. As additional peaks (not shown) are detected due to subsequent droplet ejections, a tenth peak 610 is also detected as a result of the tenth droplet ejection from the same sample source, e.g., the same sample well of a well plate. In various examples, because the peaks are close to one another, an overall peak 620 may be detected instead of 10 individual peaks, the overall peak 620 being the combination of all ten peaks 601, 602 . . . 610. In other examples, because the droplet ejection frequency is 0.1 s, the width of the overall peak 620, illustrated as baseline width Wn, as further discussed below with respect to Equation (2), is equal to about 1.9 s for 10 droplet ejections. In other examples, if 20 droplets are ejected, then the width of the overall peak 620 would be equal to 2.9 s.

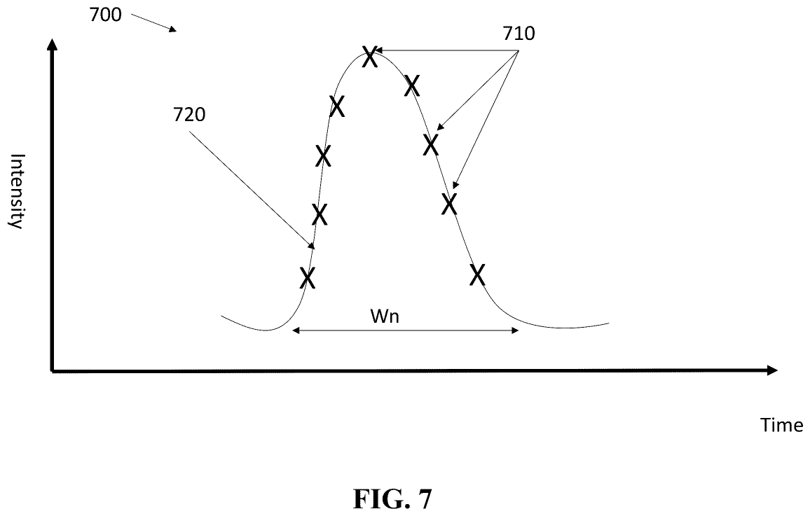

FIG. 7 illustrates data points taken from a signal peak, in accordance with various aspects and examples of the present disclosure. In FIG. 7, the chronogram 700 shows a single overall peak 720 being generated, e.g., similarly to the overall peak 620 discussed above with respect to FIG. 6. In various examples, FIG. 7 also illustrates a number of data points 710 that are taken in order to characterize the peak 720. According to various examples, 8 to 10 data points 710 may be taken for each peak 720, and the baseline peak width is illustrated as Wn.

In various examples, the relationship between a baseline peak width, the cycle time (t_{cycle}), and the number of data points across the signal duration (N_{data points}) may be described according to Equation (1) below:

$$Baseline peak width = {t}_{cycle} \times {N}_{datapoints} \qquad ( 1 )$$

In examples, when multiple MS/MS spectra are required to be analyzed, e.g., when multiple droplet ejections are performed, a longer cycle time duration may be required for performing a specific MS data acquisition method such as, e.g., collecting multiple MS/MS spectra within a cycle time duration. As a result, a longer signal duration may be needed due to the longer cycle time and a similar number of data points taken, and the total number of droplets to be ejected may need to be increased in order to achieve that longer signal duration. For example, in AEMS, the signal duration may be flexibly controlled by continuously ejecting multiple droplets. If a single droplet ejection, or droplet, generates a signal peak with a baseline width of W1, then the signal duration for multiple droplets, e.g., N droplets, ejection may be expressed in Equation (2) below:

$$Wn = W 1 + ( n - 1 ) / reprate \qquad ( 2 )$$

In Equation (2), “reprate” is the frequency of droplet ejections, and Wn is the baseline width of the peak corresponding to “n” droplets being ejected. For example, 1/reprate may be substantially smaller than W1, and as such the signal from different droplets may be merged together as a single wider signal peak such as, e.g., signal peak 620 or 720 discussed above with respect to FIGS. 6 and 7. For example, for an AEMS example of W1 being equal to 1 second, a reprate of 10 Hz or above may be typically used. In another example, a 20-droplet ejection (n=20) with reprate equal to 10 Hz and W1 equal to 1 second may result in a signal peak width Wn, calculated via Equation (2) above, of (1+(20−1)/10=) 2.9 seconds. This longer baseline width of 2.9 seconds may allow to simultaneously monitor a number of MS/MS transitions with sufficient good data quality by taking a sufficient number of datapoints 710 illustrated in FIG. 7.

FIG. 8 is a table 800 illustrating mass analysis parameters, in accordance with various examples of the present disclosure. In various examples of the disclosure, these parameters may be set based on the specific mass spectrometry technique such as, e.g., number of MS/MS spectra, in addition to the TOF MS full scans, dwell time settings, accumulation time, and the like. In various examples, the cycle time (t_{cycle}) may be automatically calculated based on equipment parameters. Accordingly, a preferred or optimized number “n” of droplets to be ejected may thus be automatically calculated based on Equations (1) and (2) above, as illustrated in Equation (3) below:

$$n = ( {t}_{cycle} \times {N}_{data points} - W 1 ) \times reprate + 1 \qquad ( 3 )$$

In Equation (3), “n” is the preferred or optimized number of droplets, t_{cycle} is the cycle time, N_{data points} is the number of data points across the signal duration, W1 is the width of a peak for a single sampling trigger or droplet ejection, and reprate is the frequency of droplet ejection. For example, the default suggested N_{data points} may be pre-set, e.g., pre-set in a software controlling operation of the mass spectrometer and may be, e.g., equal to 10. This parameter may be adjusted as needed. The frequency of droplet ejection “reprate” may also be selected, or may be dependent on the specific MS equipment and may be related to the signal level or sensitivity. In the example illustrated in FIG. 6, the reprate is equal to 10 Hz.

In other examples, the sampling or ejection delay time may be defined as described in Equation (4) below:

$$Ejection delay time = {t}_{cycle} \times {N}_{data points} \qquad ( 4 )$$

In various examples, an additional delay time may be added to the sampling or ejection delay time calculated above via Equation (4) to account for local variations of, e.g., the sample, the equipment, and the like. For example, the delay time may be calculated according to Equation (5) below, where Td is the sampling or ejection delay time, and Tad is the additional sampling or ejection delay time:

$$Td = {t}_{cycle} \times {N}_{datapoints} + Tad \qquad ( 5 )$$

In various examples, table 800 illustrates the experimental results for a single droplet ejection 810, a 10-droplet ejection 820, and a 20-droplet ejection 830. In various examples, for a single droplet ejection illustrated in 810, a one-second wide signal duration may allow up to, e.g., four (4) simultaneous or contemporaneous high-resolution multiple reaction monitoring (MRM HR) measurements to be performed while keeping a sufficient data quality. For example, the quality of the data may be measured via, e.g., the coefficient of variation (CV %) also described in table 800. In various examples, data of sufficiently quality has a coefficient of variation that is equal to or less than about 10%. Accordingly, for the single droplet ejection 810 illustrated in FIG. 8, up to four (4) MRM HR measurements may be performed while keeping the CV % in the above-discussed range of equal to or lower than 9% or lower than 10%. For example, if more than 4 MRM HR measurements are performed such as, e.g. 6 or 8 MRM HR measurements, then the resulting CV % is greater than the above-discussed range of CV %, which indicates that the data quality may not be sufficiently reliable. Accordingly, the MRM HR measurements with an acceptable CV % are those to the left of the boundary labeled 815 in table 800. In various examples, the cycle time for a single droplet ejection, is in a range of about 106 ms to 121 ms, and the accumulation time, which is the amount of measurement for each MRM HR measurement, is in a range of 20 ms to about 50 ms. In various examples, the total signal duration for a single droplet ejection may be equal to, as discussed above with respect to W1, about one second.

In other examples, for a 10-droplet ejection illustrated in 820, the signal duration may allow up to, e.g., nine (9) simultaneous or contemporaneous MRM HR measurements to be performed while keeping a sufficient data quality, as given by the CV % being equal to or less than about 9%, or equal to or less than about 10%. For example, if more than 9 MRM HR measurements are performed such as, e.g. 11 or 15 MRM HR measurements, then the resulting CV % is greater than the above-discussed range, which indicates that the data may not be sufficiently reliable. Accordingly, the MRM HR measurements with an acceptable CV % are those to the left of the boundary labeled 825 in table 800. In various examples, the cycle time for a 10-droplet ejection, is in a range of about 206 ms to 244 ms due to the increased number of MRM HR measurements, and the accumulation time is in a range of 20 ms to about 100 ms. In various examples, the total signal duration for a 10-droplet ejection is, as discussed above with respect to Equation (2), increased by 0.9 s for a total time of 1.9 s.

In other examples, for a 20-droplet ejection illustrated in 830, the signal duration may allow up to, e.g., thirteen (13) simultaneous or contemporaneous MRM HR measurements to be performed while keeping a sufficient data quality, as given by the CV % being equal to or less than about 9%, or equal to or less than about 10%. For example, if more than 13 MRM HR measurements are performed such as, e.g. 16 or 23 MRM HR measurements, then the resulting CV % is greater than the above-discussed range. Accordingly, the MRM HR measurements with an acceptable CV % are those to the left of the boundary labeled 835 in table 800. In various examples, the cycle time for a 20-droplet ejection, is in a range of about 316 ms to 312 ms due to the increased number of MRM HR measurements, and the accumulation time is in a range of 20 ms to about 50 ms. In various examples, the total signal duration for a single droplet ejection is, as discussed above with respect to Equation (2), increased by 1.9 s for a total time of 2.9 s.

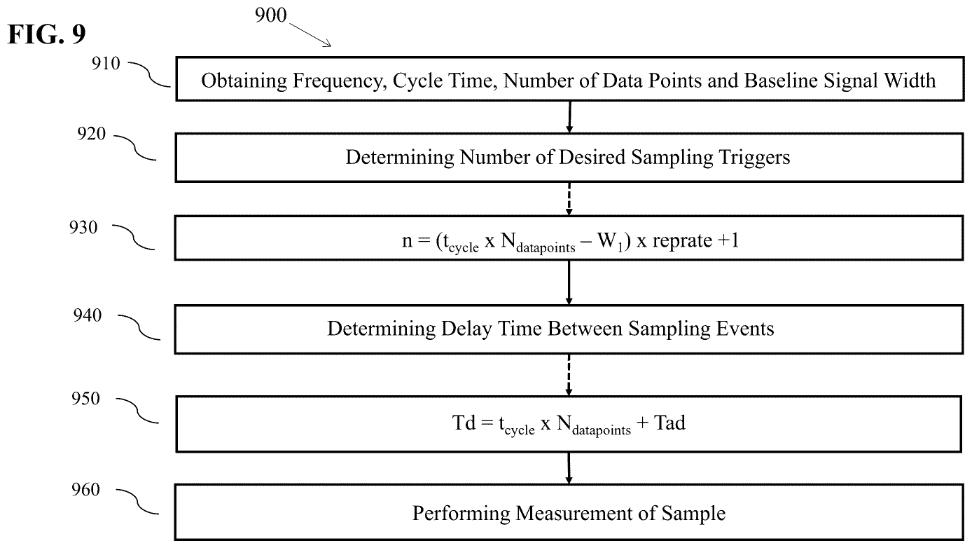

FIG. 9 represents a flowchart illustrating a method for determining sampling triggers for an analysis device, in accordance with various examples of the disclosure. In various examples, the method 900 includes operation 910 during which various parameters such as, e.g., the frequency of sampling triggers or droplet ejections, the cycle time to acquire a single mass spectrum or a group of mass spectra, the number of data points to be acquired for a single peak, and the baseline signal width of a single sampling trigger peak, may be obtained. In various examples, the sampling triggers may be, e.g., droplet ejections, and a sampling trigger peak may be a droplet ejection peak. In other examples, these parameters may be obtained by being input by a user or third party, accessed from a library via, e.g., a direct connection or a network, or otherwise obtained. In various examples, the number of data points to be acquired for the single peak may be in a range of, e.g., 7 data points to 12 data points. In other examples, the cycle time may be in a range of 100 ms to 120 ms, and up to four simultaneous or contemporaneous measurements may be performed by the analysis device. In yet other examples, the cycle time may be in a range of 200 to 250 ms and up to nine simultaneous or contemporaneous measurements may be performed by the analysis device. In still further examples, the cycle time is in a range of 300 to 350 ms and up to thirteen simultaneous or contemporaneous measurements may be performed by the analysis device.

In other examples, operation 920 includes determining a desired number of sampling triggers to be performed, and a delay time between sampling events, based on, e.g., the frequency of sampling triggers or droplet ejections, the cycle time to obtain a single mass spectrum or a group of mass spectra, the number of data points to be acquired for a single peak, and the baseline signal width of the single sampling trigger peak. In various examples, determining the desired number of sampling triggers or droplet ejections, as in operation 930, may include, or may consist of, calculating the above Equation (3), reproduced below:

$$n = ( {t}_{cycle} \times {N}_{data points} - W 1 ) \times reprate + 1 \qquad ( 3 )$$

In the above Equation (3), n is the desired number of sampling triggers or droplet ejections, t_{cycle} is the cycle time top measure a single mass spectrum or a group of mass spectra, N_{datapoints} is the number of data points, W₁ is the baseline signal width of the peak of a single sampling trigger or droplet ejection, and reprate is the frequency of sampling triggers or droplet ejections. When the sampling triggers are droplet ejections, then n is the desired number of droplet ejections and reprate is the frequency of droplet ejections.

In other examples, operation 940 includes determining a delay time between sampling events or droplet ejections. For example, determining the delay time between sampling events may be based on, e.g., the cycle time, the number of data points to be acquired for a single peak, as well as an additional sampling or ejection delay time. In examples, when the sampling triggers are droplet ejections, then the additional sampling delay time is an additional droplet ejection time. In various other examples, determining the delay time may be performed, as in operation 950, via Equation (5) discussed above.

In other examples, operation 960 includes performing a measurement of a sample. For example, performing the measurement of the sample during operation 960 may include executing the determined desired number of sampling triggers from the sample. In various examples, when the sampling triggers are droplet ejections, then executing the determined desired number of sampling triggers may include ejecting the desired number of droplets from the sample source. In various examples, operation 960 may further include ionizing the ejected desired number of droplets, and capturing one or more mass spectra for the ionized droplets. In other examples, operation 960 further includes calculating a sample ejection volume based on the number of ejected droplets and a volume of an individual droplet. In various examples of the above aspects, a coefficient of variation of a signal intensity for a plurality of measurements performed during operation 960 may be equal to or lower than 10%, which indicates a sufficient data reliability.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a processor, a microprocessor, a programmable computer or an electronic circuit. In some examples, some one or more of the most important method steps may be executed by such an apparatus.

Generally, examples of the present disclosure can be implemented through the use of computer program products with program codes, the program codes being operative for performing the operations described herein when the computer program product runs on a computer such as may be used to embody any or all of controllers such as, 135, 82, 92, 96, 107, 127 or 330.

Although various examples and examples are described herein, those of ordinary skill in the art will understand that many modifications may be made thereto within the scope of the present disclosure. Accordingly, it is not intended that the scope of the disclosure in any way be limited by the examples provided.

1. A method of determining sampling triggers for an analysis device, the method comprising:
obtaining a frequency of sampling triggers, a cycle time to acquire a single data point, a number of data points to be acquired for a single peak, and a baseline signal width of a single sampling trigger peak;
determining a desired number of sampling triggers to be performed and a delay time between sampling events based on the frequency of sampling triggers, the cycle time, the number of data points to be acquired for the single peak, and the baseline signal width of the single sampling trigger peak; and
performing a measurement of a sample by executing the determined desired number of sampling triggers from the sample.

2. The method of claim 1, wherein determining the desired number of sampling triggers comprises calculating:
$$n = ( {t}_{cycle} \times {N}_{datapoints} - {W}_{1} ) \times reprate + 1 ;$$
wherein:
n is the desired number of sampling triggers;
t_{cycle} is the cycle time;
N_{datapoints} is the number of data points;
W₁ is the baseline signal width of the single sampling trigger; and
reprate is the frequency of sampling triggers.

3. The method of claim 1, wherein the number of data points to be acquired for the single peak is in a range of 7 to 12.

4. The method of claim 1, wherein a coefficient of variation of a signal intensity for a plurality of measurements is equal to or lower than 10%.

5. The method of claim 4, wherein the cycle time is in a range of 100 ms to 120 ms and up to four measurements can be performed by the analysis device.

6. The method of claim 4, wherein the cycle time is in a range of 200 to 250 ms and up to nine measurements can be performed by the analysis device.

7. The method of claim 4, wherein the cycle time is in a range of 300 to 350 ms and up to thirteen measurements can be performed by the analysis device.

8. The method of claim 1, further comprising:
obtaining an additional sampling delay time; and
determining the sampling delay time between sampling events comprises calculating:
$$Td = {t}_{cycle} \times {N}_{datapoints} + Tad ;$$
wherein:
Td is the sampling delay time; and
Tad is the additional sampling delay time.

9. (canceled)

10. (canceled)

11. (canceled)

12. (canceled)

13. A sample analyzing system comprising:
a sample receiver;
an analysis device fluidically coupled to the sample receiver;
a processor operatively coupled to the sample receiver and to the analysis device; and
a memory coupled to the processor, the memory storing instructions that, when executed by the processor, perform a set of operations comprising:
obtaining, via the processor, a frequency of sampling triggers, a cycle time to acquire a single data point, a number of data points to be acquired for a single peak, and a baseline signal width of a single sampling trigger peak;
determining, via the processor, a desired number of sampling triggers to be performed and a delay time between sampling events based on the frequency of sampling triggers, the cycle time, the number of data points to be acquired for the single peak, and the baseline signal width of the single sampling trigger peak; and
performing, via the analysis device, a measurement of a sample by executing the determined desired number of sampling triggers from the sample.

14. The system of claim 13, wherein the set of instructions comprises determining the desired number of sampling triggers by calculating:
$$n = ( {t}_{cycle} \times {N}_{datapoints} - {W}_{1} ) \times reprate + 1 ;$$
wherein:
n is the desired number of sampling triggers;
t_{cycle} is the cycle time;
N_{datapoints} is the number of data points;
W₁ is the baseline signal width of the single sampling triggers; and
reprate is the frequency of sampling triggers.

15. The system of claim 13, wherein the number of data points to be acquired for the single peak is in a range of 7 to 12.

16. The system of claim 13, wherein a coefficient of variation of a signal intensity for a plurality of measurements is equal to or lower than 10%.

17. The system of claim 16, wherein the cycle time is in a range of 100 ms to 120 ms and up to four measurements can be performed by the analysis device.

18. (canceled)

19. (canceled)

20. The system of claim 13, wherein the set of instructions further comprises:
obtaining an additional sampling delay time; and
determining the sampling delay time between sampling events comprises calculating:
$$Td = {t}_{cycle} \times {N}_{datapoints} + Tad ;$$
wherein:
Td is the sampling delay time; and
Tad is the additional sampling delay time.

21. The system of claim 13, wherein:
the sampling triggers are droplet ejections;
the sampling delay time is a droplet ejection delay time; and
the additional sampling delay time comprises an additional droplet ejection delay time.

22. The system of claim 13, wherein:
the sample analysis system further comprises a sample ejector for ejecting a sample from a sample source, and a sample ionization device;
the analysis device is a mass analysis device;
the sampling triggers are droplet ejections; and
the set of instructions further comprises performing the determined desired number of sampling triggers by ejecting a same desired number of droplets from the sample via the sample ejector.

23. The system of claim 22, wherein the set of instructions further comprises:
ionizing the ejected desired number of droplets; and
capturing one or more mass spectra for the ionized droplets.

24. The system of claim 22, wherein the set of instructions further comprises calculating a sample ejection volume based on the number of droplets and a volume of an individual droplet.

25. The system of claim 13, wherein the sample receiver comprises an open port interface.

26. The system of claim 13, wherein the sample ejector is a non-contact sample ejector.
